(19) United States
(12) Patent Application Publication
(10) Pub. No.: US 2015/0017475 A1
(43) Pub. Date: Jan. 15, 2015

(54) PROCESSING OF METAL OR ALLOY OBJECTS

(71) Applicant: Charles Malcolm Ward-Close, Hampshire (GB)

(72) Inventor: Charles Malcolm Ward-Close, Hampshire (GB)

(21) Appl. No.: 14/380,100

(22) PCT Filed: Feb. 20, 2013
(86) PCT No.: PCT/GB2013/050409

§ 371 Date: Aug. 21, 2014

(30) Foreign Application Priority Data
Feb. 24, 2012 (GB) 1203359.3

(51) Int. Cl. B23K 20/00; B23K 20/02; B32B 15/01

(52) U.S. Cl. CPC B23K 20/002; B32B 15/01; B23K 20/02; B23K 20/233
USPC 428/660; 228/101; 228/193

(57) ABSTRACT

Disclosed are methods of processing an object, the object being made of a metal or an alloy, the object having a plurality of open cavities, the method comprising: performing a sealing process on the object to seal the openings of the open cavities, thereby forming a plurality of closed cavities; and reducing the sizes of the closed cavities by performing a consolidation process on the object having the closed cavities. Sealing process may comprise shot peening or coating the object. A consolidation process may comprise a hot isostatic pressing process. The sizes of the closed cavities may be reduced until the closed cavities are no longer present in the object.

### CROSS-REFERENCE TO RELATED APPLICATION

This application is the National Stage of International Application No. PCT/GB2013/050409, filed 20 Feb. 2013, which claims the benefit of and priority to GB 1203359.3, filed 24 Feb. 2012, the contents of all of which are incorporated by reference as if fully set forth herein.

### FIELD OF THE INVENTION

The present invention relates to the processing of objects, in particular objects made of metals or alloys.

### BACKGROUND

Metals and metal alloys are used in many market sectors, including the aerospace, medical and sports and leisure sectors.

The manufacture of metal or alloy objects may be performed by machining processes or a combination of forging and machining processes. Objects may also be made using casting and/or powder metallurgy routes, for example using a metal injection moulding process.

However, such manufactured objects, particularly those made by powder metallurgy processes, may comprise micro-pores and other imperfections at or proximate to the surface of the object. The presence of such imperfections tends to adversely affect the fatigue performance of an object, especially in high-cycle fatigue situations. For example, the imperfections may act as crack initiators.

Hot isostatic pressing tends not to remove such imperfections if they are connected to the surface.

### SUMMARY OF THE INVENTION

In a first aspect, the present invention provides a method of processing an object, the object being made of a metal or an alloy, the object having a plurality of open cavities, the method comprising performing a sealing process on the object to seal the openings of the open cavities, thereby forming a plurality of closed cavities, and reducing the sizes of the closed cavities by performing a consolidation process on the object having the closed cavities.

The step of reducing the sizes of the closed cavities may be performed at least until the closed cavities are no longer present in the object.

The step of performing a consolidation process may comprise performing a hot isostatic pressing process.

The object may be an object that has been produced using a process selected from a group of processes consisting of: net shape manufacturing processes, near net shape manufacturing processes, powder metallurgy processes, spray forming processes, metal injection moulding, direct metal deposition, selective laser melting, additive layer manufacturing, casting, rolling, and forging.

The object may be an object that has been produced using a metal injection moulding to form the object.

The object may be a brown stage object that has been sintered.

The step of performing a sealing process may comprise plastically deforming the surface of the object.

Plastically deforming the surface of the object may comprise shot peening the surface of the object.

The step of performing a sealing process may further comprise sintering the object after the surface of the object has been plastically deformed.

The step of performing a sealing process may comprise coating the surface of the object with a layer of material thereby providing a coated object, wherein the material is a metal or alloy that is different to the metal or alloy from which the object is made.

The step of performing a sealing process may further comprise heating the coated object such that atoms from the layer of material diffuse into the object, and such that atoms from the object diffuse into the layer of material.

The step of heating the coated object may comprise melting a portion of the coated object, the portion being at or proximate to the surface of the coated object.

The layer of material and the object may form a eutectic composition at or proximate to the interface between the layer of material and the object.

The step of heating the coated object may comprise heating the coated object to a temperature, the temperature being above a eutectic temperature of the eutectic composition, and the temperature being below a melting point of the metal or alloy from which the object is made.

The material may comprise copper.

The metal or alloy from which the object is made may be selected from a group of metals or alloys consisting of: titanium alloys, steel, and aluminium alloys.

In a further aspect, the present invention provides a method of producing an object, the method comprising providing an initial object, the initial object being made of a metal or an alloy, the initial object having a plurality of open cavities, and processing the initial object using a method according to any of the above aspects, thereby providing the produced object.

In a further aspect, the present invention provides an object that has been produced or processed using a method according to any of the above aspects.

### BRIEF DESCRIPTION OF THE DRAWINGS

FIG. 1 is a schematic illustration (not to scale) of an object;

FIG. 2 is a process flow chart showing certain steps of a process of producing the object;

FIG. 3 is a schematic illustration (not to scale) of a cross section of a portion of a sintered part;

FIG. 4 is a schematic illustration (not to scale) of the cross section of the portion of the sintered part after having been shot peened;

FIG. 5 is a schematic illustration (not to scale) of the cross section of the portion of the shot peened part after having been re-sintered;

FIG. 6 is a schematic illustration (not to scale) of the cross section of the portion of the re-sintered part after having a hot isostatic pressing process performed on it;

FIG. 7 is a process flow chart showing certain steps of a further process of producing the object;

FIG. 8 is a schematic illustration (not to scale) of a cross section of a portion of a sintered part after having been coated with a copper layer;

FIG. 9 is a schematic illustration (not to scale) of the cross section of the portion of the copper coated part when heated; and

FIG. 10 is a schematic illustration (not to scale) of the cross section of the portion of the heated part after the copper layer has diffused into it.

### DETAILED DESCRIPTION

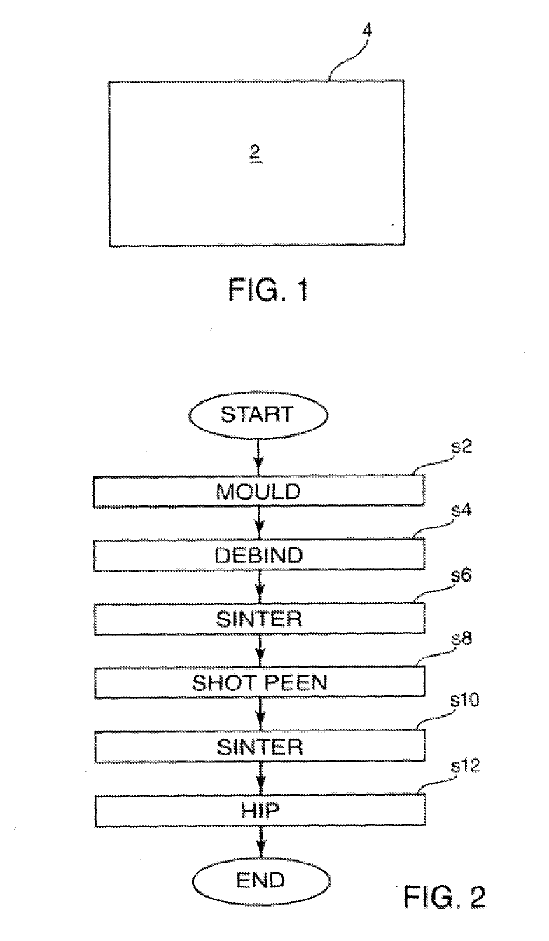

FIG. 1 is a schematic illustration (not to scale) of an object 2. The object 2 is made of a titanium alloy. The object 2 may be any appropriate object e.g. a component part of a machine or machinery. The object has a surface 4. A first embodiment of a process of producing the object 2 will now be described.

FIG. 2 is a process flow chart showing certain steps of a first embodiment of a process of producing the object 2.

At step s2, a metal injection moulding process is performed to produce a so-called “green part”.

In this embodiment, a conventional metal injection moulding process is performed. A relatively finely-powdered alloy is mixed with binder material to produce a so called “feedstock”. This feedstock is shaped using an injection mould process to produce the green part.

In this embodiment, the alloy is titanium with 6% aluminium and 4% vanadium (also known as Ti-6Al-4V, or 6-4, 6/4, ASTM B348 Grade 5).

At step s4, after the green part is cooled and de-moulded, a portion of the binder material is removed from the green part to produce a so-called “brown part”.

In this embodiment, a conventional process for removing binder material from the green part is used, e.g. by using a solvent, a thermal evaporation, and/or a catalytic process, etc.

In this embodiment, the brown part produced by the metal injection moulding and binder removal processes has a solid density of approximately 60%. In other words, the brown part is relatively porous.

Also, the brown part has substantially uniform porosity throughout the part. The surface and internal structure of the brown part have substantially equal porosity.

At step s6, a sintering process is performed on the brown part. A conventional sintering process is used.

In this embodiment, the brown part is sintered at a temperature in the range 1000° C. to 1300° C. Preferably, the brown part is sintered at a temperature in the range 1250° C. to 1300° C. This sintering process tends to agglomerate the metal particles in the brown part, thereby increasing the solid density of the part.

The component formed by sintering the brown part has a solid density within the range 92% to 100%. In other words, the sintered brown part is relatively solid. The terminology “solid” is used herein to refer to a material that has a density by volume (i.e. solid density) of between 92% and 100%.

The brown part after it has been sintered will hereinafter be referred to as the “sintered part”.

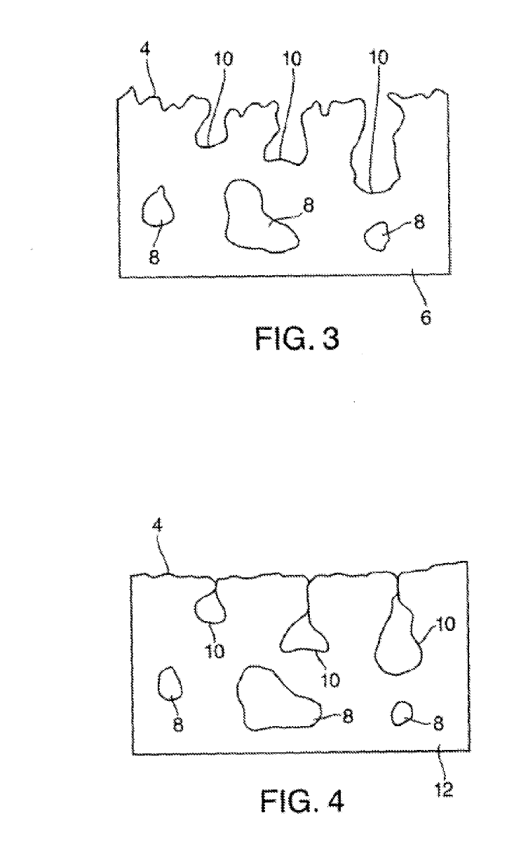

FIG. 3 is a schematic illustration (not to scale) of a cross section of a portion of the sintered part 6. The portion shown in FIG. 3 is proximate to the surface of the sintered part 6 (which is the surface of the produced object 2 and so is indicated in FIG. 3 by the reference numeral 4)

The surface 4 of the sintered part 6 is relatively uneven, i.e. rough.

Proximate to its surface 4, the sintered part 6 comprises a plurality of closed cavities 8 (i.e. closed pores or voids in the material body). These closed cavities 8 are hollow spaces or pits in the body of the sintered part 6. Furthermore, the closed cavities 8 are not open to the atmosphere, i.e. they are not connected to the surface 4. In other words, gas cannot flow from outside the sintered part 6 into the closed cavities 8 and vice versa.

The sintered part 6 further comprises a plurality of open cavities 10 (i.e. open pores or voids in the material body). These open cavities 10 are cavities or hollows that are open to the atmosphere, i.e. cavities or hollows that are connected to the surface 4 such that gas can flow from outside the sintered part 6 into the those open cavities.

The sintered part 6 may, for example, have an average surface roughness of approximately ±10 μm with a periodicity of approximately 10-20 μm. Open cavities 10 may, for example, be up to 60 μm deep. In other embodiments, the open cavities 10 may, for example, extend into the sintered part 6 from its surface 4 to a depth of up to 200 μm.

In conventional methods, after the sintered part 6 has been formed, a hot isostatic pressing (HIP) process is typically performed on the sintered part 6 to reduce the porosity, and increase the density, of the part. Were a HIP process performed on the sintered part 6 (as is performed conventionally), the sintered part 6 would be subjected to elevated temperature and elevated isostatic gas pressure, e.g. by subjecting the sintered part 6 to a heated, pressurised gas such as argon. Thus, there would be relatively high pressure on the surface 4 of the sintered part 6, whilst there would be relatively low pressure in the closed cavities 8 (due to their not being open to the surface 4). The application of heat and the creation of a pressure differential between the atmosphere and the closed cavities 8 would tend to cause the closed cavities 8 to shrink, or vanish completely. This may be due to a combination of plastic deformation, creep, and diffusion bonding caused by the elevated temperature and pressure. However, a conventional HIP process performed on the sintered part 6 would tend not to shrink, or remove, the open cavities 10 from the sintered part 6. The heated pressurised gas applied to the sintered part 6 during the HIP process may flow into the open cavities 10. Thus, there would tend to be no pressure differential between the atmosphere and the open cavities 10, and the open cavities 10 would therefore not be closed by the HIP process.

This deficiency of conventional methods of producing objects/parts may be overcome by performing steps s8 to s12 on the sintered part 6, as opposed to just performing a HIP process.

At step s8, the sintered part 6 (produced by performing steps s2 to s6) is shot peened.

In this embodiment, a conventional shot peening process is used. This process comprises impacting a surface 4 of the sintered part 6 with shot (e.g. substantially round particles made of metal, glass, or ceramic) with sufficient force such that the sintered part 6 is plastically deformed at its surface 4.

In this embodiment, any appropriate shot medium may be used, e.g. S330 (cast steel with an average diameter of 0.8 mm). Also, any appropriate shot peening pressure may be used, e.g. 0.5 bar, 0.75 bar, 1.25 bar, 2 bar and 4 bar. Also, any appropriate Almen intensities may be used, e.g. 0.15 mmA, 0.20 mmA, 0.30 mmA, 0.38 mmA and 0.52 mmA.

FIG. 4 is a schematic illustration (not to scale) of the cross section of a portion of the sintered part 6 after having been shot peened. This part will hereinafter be referred to as the “shot peened part” and is indicated in FIG. 4 by the reference numeral 12. The portion of the part shown in FIG. 4 is the same portion as shown in FIG. 3.

The surface 4 of the show peened part 12 is relatively smooth (compared to the surface 4 prior to shot peening).

Furthermore, the process of shot peening tends to plastically deform the sintered part 6 at its surface 4 such that the openings of the open cavities 10 are either closed such that gas cannot flow from outside the sintered part 6 into an open cavity 10 and vice versa (i.e. such that, in effect, an open cavity 10 becomes a closed cavity 8), or are closed such that the opening of an open cavity 10 to the surface 4 is very small but that gas may still flow from outside the sintered part 6 into an open cavity 10 and vice versa.

In this embodiment, the plastic deformation of the surface of the sintered part 6 is performed by shot peening. However, in other embodiments a different plastic deformation process is used, for example, a process of burnishing e.g. using a roller.

At step s10, the shot peened part 12 is re-sintered.

A conventional sintering process, such as that used at step s6, may be used. For example, the sintering of the shot peened part 12 may comprise sintering at a temperature in the range 1000° C. to 1300° C., and preferably at a temperature in the range 1250° C. to 1300° C. The sintering process is performed for a time period at a temperature for diffusion bonding the compacted open cavities 10 near the surface, for example in the range 750-1400° C.

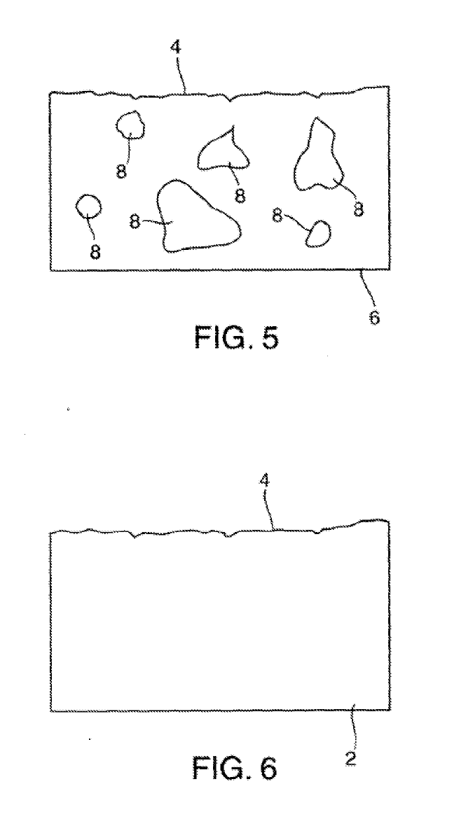

FIG. 5 is a schematic illustration (not to scale) of the cross section of a portion of the shot peened part 12 after having been re-sintered. This part will hereinafter be referred to as the “re-sintered part” and is indicated in FIG. 5 by the reference numeral 14. The portion of the part shown in FIG. 5 is the same portion as shown in FIGS. 3 and 4.

The sintering of the shot peened part 12 tends to agglomerate the metal particles of the shot peened part. In particular, the sintering process tends to diffusion bond the openings of the open cavities 10 (that were either closed or almost closed by the shot peening process) such that, in effect, the open cavities 10 become closed cavities 8 (as shown in FIG. 5). In other words, the openings of the open cavities 10 are fully sealed by sintering the part 12, i.e. the re-sintering of the shot peened part 12 tends to close the open cavities 10 such that gas cannot flow from outside the shot peened part 12 into an open cavity 10 and vice versa. In other words, the open cavities 10 are made impermeable to fluids.

At step s12, a hot isostatic pressing (HIP) process is performed on the re-sintered part 14.

A conventional HIP process is used to reduce the porosity, and increase the density, of the re-sintered part 14. In this embodiment, the re-sintered part 14 is subjected to elevated temperature and elevated isostatic gas pressure by subjecting the re-sintered part 14 to heated and pressurised argon. A HIP cycle having a duration of approximately 2 hours, a temperature of 920° C., and a pressure of 102 MPa may be used. FIG. 6 is a schematic illustration (not to scale) of the cross section of a portion of the re-sintered part 14 after having a HIP process performed on it. The hot isostatic pressing of the re-sintered part 14 produces the object 2. The portion of the part shown in FIG. 6 is the same portion as shown in FIGS. 3 to 5

The HIP process produces a relatively high pressure at the surface 4 of the re-sintered part 14, whilst the pressures in the closed cavities 8 (including the open cavities 10 that have been formed into closed cavities 8 as described above) are relatively low. This is due to the closed cavities 8 not being open to the surface 4, i.e. being gas-tight. As a result of plastic deformation, creep, and/or diffusion bonding caused by the elevated temperature and pressure, the closed cavities 8 in the re-sintered part shrink or vanish completely.

The hot isostatic pressing of the re-sintered part 14 produces the object 2. Thus, a process of producing the object 2 is provided.

In the above described first embodiment, the object 2 is produced using a shot peening and re-sintering treatment. A second, alternative, embodiment of a process of producing the object 2 in which a different treatment will now be described.

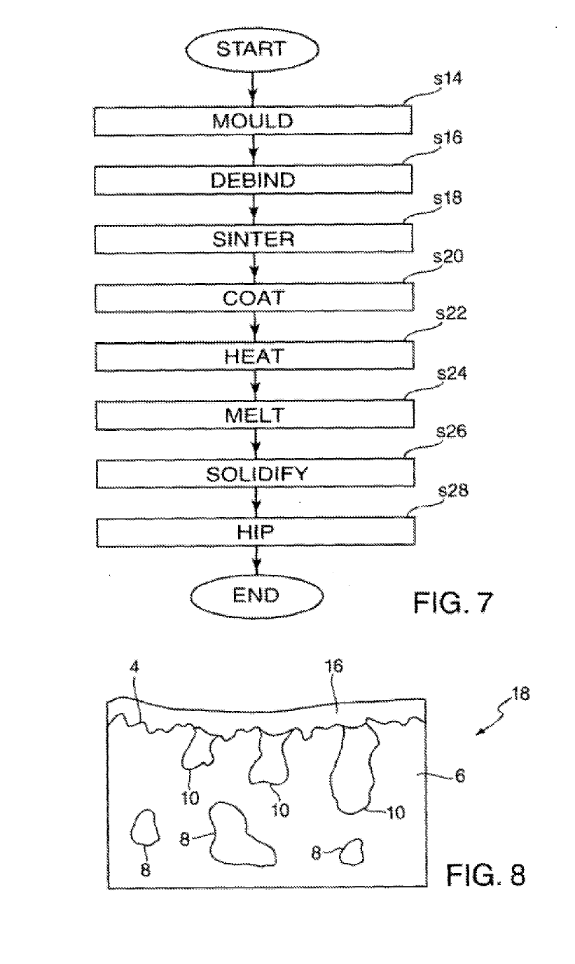

FIG. 7 is a process flow chart showing certain steps of a second embodiment of a process of producing the object 2.

At step s14, a metal injection moulding process is performed to produce a green part. This is done as described above with reference to step s2 of FIG. 2.

At step s16, a portion of the binder material is removed from the green part to produce a brown part. This is done as described above with reference to step s4 of FIG. 2.

At step s18, a sintering process is performed on the brown part to produce a sintered part 6. This is done as described above with reference to step s6 of FIG. 2.

The sintered part 6 at step s18 is as described above with reference to FIG. 3.

At step s20, the surface 4 of the sintered part 6 is coated, or plated, with a layer of copper.

The coating of the surface of the sintered part 6 may be performed using any appropriate coating or plating process, for example electro-plating.

FIG. 8 is a schematic illustration (not to scale) of the cross section of a portion of the sintered part 6 after having been coated with a copper layer 16. This part will hereinafter be referred to as the “coated part” and is indicated in FIG. 8 by the reference numeral 18. The portion of the part shown in FIG. 8 is the same portion as shown in FIG. 3.

In this embodiment, the copper layer 16 covers the entire surface 4 of the sintered part 6.

At step s22, the coated part 18 is heated.

At the interface between the titanium alloy part and the copper layer 16, i.e. at the surface 4, titanium atoms tend to diffuse into the copper layer 16 and copper atoms tend to diffuse into the titanium alloy. At some point at or near the interface between the titanium alloy and copper layer a eutectic composition is formed, i.e. a layer of a eutectic composition tends to form. This eutectic composition of titanium and copper has a lower melting temperature than the titanium alloy from which the sintered part 6 is formed. This eutectic composition also has a lower melting temperature than the copper layer.

The heating of the coated part 18 at step s22 is performed such that the coated part 18 is heated to above the melting point of the eutectic composition. In other words, the coated part 18 is heated to above the eutectic temperature of the titanium/copper composition.

Thus, at step s24, the eutectic composition of titanium and copper formed at the surface 4 of the sintered part 6 melts.

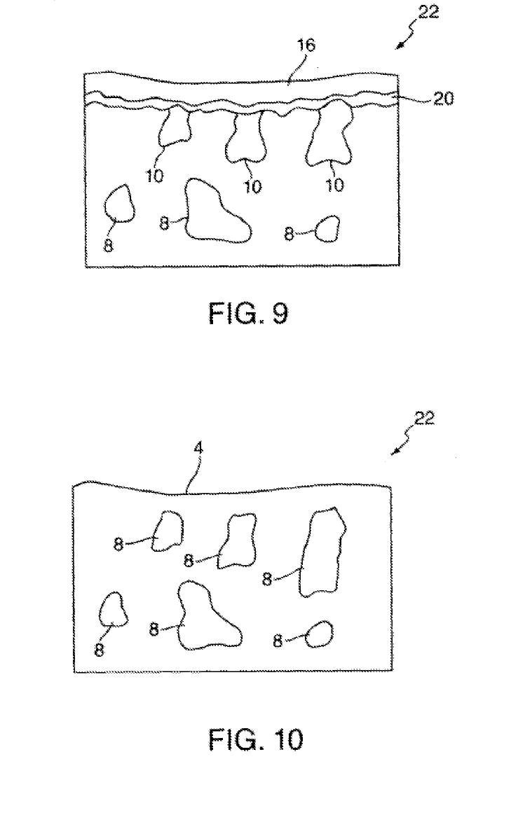

FIG. 9 is a schematic illustration (not to scale) of the cross section of a portion of the coated part 18 heated to above the eutectic temperature of the titanium/copper eutectic composition. A molten, i.e. liquid, layer 20 is formed at the interface between the titanium alloy material and the copper layer 16. This part will hereinafter be referred to as the “heated part” and is indicated in FIG. 9 by the reference numeral 22. The portion of the part shown in FIG. 9 is the same portion as shown in FIGS. 3 and 8.

As the heating of heated part 22 is continued, more and more titanium and copper tends to dissolve into the liquid layer 20 and the thickness of the liquid layer 20 increases until the entire solid copper layer 16 has been dissolved into the liquid layer 20.

Also, as heating of the heated part 22 is continued, copper atoms tend to diffuse into the titanium alloy material away from the surface 4. Also, more titanium atoms tend to diffuse into the liquid layer 20. Thus, the proportion of titanium in the liquid layer 20 tends to increase. This change in the composition of the liquid layer 20 tends to increase its melting temperature. Thus, the liquid layer 20 solidifies.

Thus, at step s26, after a certain amount of time being heated, the material at the surface of the heated part 22 solidifies. In other words, the copper layer 16 has diffused into the titanium alloy material (and vice versa) to such a degree that the melting point of the titanium/copper composition is greater than the eutectic temperature, and greater than the temperature to which the heated part 22 is heated.

FIG. 10 is a schematic illustration (not to scale) of the cross section of a portion of the heated part 22 after the copper layer 16 has diffused into it, and the surface of the molten layer 20 has solidified. The portion of the part shown in FIG. 10 is the same portion as shown in FIGS. 3, 8 and 9.

The dissolution of the outer surface of the titanium part into the liquid layer 20 together with the subsequent re-solidification of that layer tends to close the openings of the open cavities 10 such that, in effect, the open cavities 10 become closed cavities 8 (as shown in FIG. 10). In other words, after the copper layer 16 has diffused into the titanium alloy material, and the surface of the heated part 22 has solidified, the openings of the open cavities 10 are fully sealed i.e. such that gas cannot flow from outside the heated part 22 into an open cavity 10 and vice versa. In other words, the open cavities 10 are made impermeable to fluids.

The heating of the heated part 22 may be performed until the copper is substantially uniformly diffused throughout the heated part 22.

The surface 4 of the heated part 22 is relatively smooth (compared to the surface 4 of the sintered part 6).

At step s28, a hot isostatic pressing (HIP) process is performed on the re-sintered part 14. This is done as described above with reference to step s12 of FIG. 2.

The HIP process tends to cause the closed cavities 8 in the part shrink or vanish completely as described in more detail above with reference to step s12 of FIG. 2.

The hot isostatic pressing of the heated part 22 produces the object 2. The object 2 produced using the method of the second embodiment comprises an amount of copper. Thus, a further process of producing the object 2 is provided.

An advantage provided by the above described methods is that pores, pits, or other (e.g. minute) openings, orifices, or interstices in the surface of the object tend to be removed. In other words, defects and/or discontinuities at or proximate to the surface of the object may, in effect, be repaired. Conventional processes of performing a hot isostatic pressing process on a sintered part tend not to remove such open cavities. These open cavities may act as crack initiators. Thus, removal of these open cavities from the object tends to result in improved fatigue performance, especially in high-cycle fatigue situations. The improved surface finish and microstructure of the object tend to improve its fatigue performance.

The above described methods also tend to remove (or shrink) the closed cavities (or other voids or hollows that are closed to the surface) in the body of the object. This also tends to improve the microstructure of the object, which tends to lead to improved fatigue performance.

A further advantage provided by the above described methods is that the surface finish of the object tends to be improved. The object tends to be shinier than those that are produced using conventional techniques. This increased reflectivity is important in certain applications. For example, if the object is for decorative purposes, the improved aesthetic appearance of the object tends to be important.

A further advantage provided by the above described processes is that an object may be produced using a powder metallurgy manufacturing technique. This tends to provide that a near-net-shape component is produced with very little wastage. Furthermore, it tends to be relatively easy to make relatively complex shapes that may be prohibitively expensive to machine.

The above described processes are advantageously applicable to objects of any size. This is because a treatment process (i.e. a process of shot peening, re-sintering, and hot isostatic pressing, or a process of coating, heating, and hot isostatic pressing) is performed after the formation of the object (i.e. after the alloy powder has been sintered).

A further advantage provided by the above described processes is that any of the treatment processes may be performed on a large number of objects simultaneously. Thus, a cost of performing any or all of these operations (per component) may be significantly reduced.

In the second embodiment, the thickness of the copper layer may be small in comparison to the size of the object. Thus, the amount of copper used in the process of FIG. 7 is relatively small compared to the amount of titanium alloy. Advantageously, the amount of copper is so small that diffusion of that amount of copper into the titanium alloy (as described above with reference to steps s24 and steps s26 of FIG. 7) tends not to adversely affect the mechanical properties of the titanium alloy object to any significant degree.

Advantageously, the above described process tends to seal the surface of the object, and so make that object more amenable to a HIP process. The above described process may advantageously be applied objects that have open porosity throughout the body of the object. In such applications, an initial sinter (i.e. the sintering of the brown part performed at step s6 or s18 of the above described embodiments) may be performed at a lower temperature and/or for a shorter time.

It should be noted that certain of the process steps depicted in the flowcharts of FIGS. 2 and 7 and described above may be omitted or such process steps may be performed in differing order to that presented above and shown in those Figures. Furthermore, although all the process steps have, for convenience and ease of understanding, been depicted as discrete temporally-sequential steps, nevertheless some of the process steps may in fact be performed simultaneously or at least overlapping to some extent temporally.

In the above embodiments, the object is formed using a process comprising a metal injection moulding process. However, in other embodiments the object is formed using a different process. For example, an object may be manufactured using one or a combination of the following processes: a machining process, a forging process, a casting process, a powder metallurgy process. Also for example, the object may be formed using a different net-shape or near-net shape manufacturing process. The terminology “near-net shape manufacturing process” is used herein to refer to processes in which the initial production of the item is (substantially) the same as, or very close (i.e. within allowed tolerances) to, the final (net) shape. This tends to reduce the need for surface finishing of the object. For example, in other embodiments an object may be produced using one or more of the following near-net shape manufacturing processes: casting, permanent mould casting, powder metallurgy, linear friction welding, metal injection moulding, rapid prototyping, spray forming, and superplastic forming. Such processes may comprise using other powder metallurgy processes. Such processes may include, for example, hot isostatic pressing (HIP), cold isostatic pressing (CIP), and 3D powder melt methods using scanning laser or electron beams. Such process may be used to form a fully or partially consolidated metal or alloy object. Such processes may use feedstock produced by a conventional ingot route, or they may use solid feedstock materials, such as a billet, plate, or bar made from lower cost, higher oxygen alloy powder via a powder metallurgy route. The metal/alloy powders used to produce the object may, for example, be blended elemental powders. For example, an object that is made of Ti-6Al-4V can be produced from a blended elemental powder made by blending powders of titanium, aluminium and vanadium. Blended elemental powders tend to alloy and homogenise during a sintering process. An object that is made of Ti-6Al-4V can also be produced from a blended elemental powder made by blending titanium powder with an Al—V master alloy powder.

In other embodiments, a treatment process (e.g. a process of shot peening, re-sintering, and hot isostatic pressing, or a process of coating, heating, and hot isostatic pressing) may be performed on any appropriate object e.g. an object with an undesirably irregular surface and/or internal defects that cannot be closed by hot isostatic pressing because they are connected to the surface. The objects may be, for example, made of titanium alloys, steels or aluminium alloys. The object may, for example, have a solid or partially solid shape or form. The object may have been produced using any process, for example near net shape processing, powder metallurgy, spray forming, metal injection moulding, direct metal deposition, selective laser melting, additive layer manufacturing, casting, rolling, forging etc.

In the above embodiments, the object is formed from an alloy comprising titanium with 6% aluminium and 4% vanadium (also known as Ti-6Al-4V, or 6-4, 6/4, ASTM B348 Grade 5). However, in other embodiments, the object is formed from a different material. For example, in other embodiments, the object is formed from a pure (i.e. unalloyed) metal, or a different type of alloy to that used in the above embodiments.

In the above embodiments, the treatment processes (i.e. a process of shot peening, re-sintering, and hot isostatic pressing, or a process of coating, heating, and hot isostatic pressing) are performed on a single object. However, in other embodiments, a treatment process, or part of a treatment process, may be performed on any number of (different or the same) objects. This advantageously tends to reduce the cost of the process per component.

In the above embodiments, the sintering (including re-sintering) of the object is performed at the above specified temperatures, and for the above specified time-periods. However, in other embodiments sintering of an object is performed at a different appropriate temperature and/or for a different appropriate time period.

In the above embodiments, the HIP process is performed at the above specified temperatures and pressures, and for the above specified time-periods. However, in other embodiments a HIP process is performed at a different appropriate temperature and/or pressure, and/or for a different appropriate time period.

In certain of the above embodiments, the surface of the sintered part is coated, or plated, with a layer of copper. This is done to form a eutectic composition at the surface of the part. However, in other embodiments, the surface of the part is coated with a different substance so as to form a different eutectic composition at the surface of the part.

Also, in other embodiments, the surface of the part is coated with a different substance that does not form a eutectic composition with titanium. For example, in another embodiment, the surface of the part is coated with a layer of aluminium. The aluminium melts at a lower temperature than the titanium alloy material. After having been coated with a layer of aluminium, the coated part may be heated to a temperature that is above the melting point of aluminium, but is below the melting point of the titanium alloy. Thus, a liquid layer of material is formed over the surface of the sintered part, i.e. the surface of the sintered part is “wetted” by the molten aluminium. Titanium atoms tend to diffuse into the molten aluminium layer, and aluminium atoms tend to diffuse into the titanium alloy body. After a certain amount of diffusion, the openings of the open cavities tend to be closed and the method may then proceed as described above. In such embodiments, the sintered part may be produced from a titanium alloy containing less than the desired proportion of aluminium. The diffusion of the aluminium layer into the part may be such that, after the diffusion, the proportion of aluminium in the part is increased to the desired level (e.g. such that the part, after having an aluminium layer diffused into it, has the composition of Ti-6Al-4V). Furthermore, an allowable composition range for aluminium in Ti-6Al-4V tends to be sufficiently large to allow or for an object made of Ti-6Al-4V to absorb a significant amount of extra aluminium and it still meet the composition specification.

Also, in other embodiments, instead of allowing all of the material used to coat/plate the sintered part (e.g. all of the copper, aluminium etc.) to diffuse into the sintered part, a portion of this coating material may be removed from the surface of the part, e.g. by washing, acid pickling or evaporating it off.

In the above embodiments, the sealing process performed on the object to seal the openings of the open cavities (i.e. the process of shot peening and sintering, or the process of coating and heating) is performed once before the HIP process is performed on the object. However, in other embodiments, before the HIP process is performed, one or both of the sealing processes may be performed multiple times. For example, the sealing process of shot peening and sintering may be performed more than once. In such an example, the sintering process that follows a shot peening process, tends to soften the work hardened surface formed during shot peening and tends to disperse any surface contamination into the bulk of the object, making the surface of the object more amenable to another shot peening process. Furthermore, the second, and any subsequent, shot peening processes may be performed at a lower intensity than the first shot peening process. This tends to result in a better surface appearance.

1-19. (canceled)

20. A method of processing an object, the object being made of a metal or an alloy, the method comprising:
coating the surface of the object with a solid layer of material thereby providing a coated object, wherein the material is a metal or alloy that is different to the metal or alloy from which the object is made, the layer of material and the object forming a eutectic composition at or proximate to the interface between the layer of material and the object; and
heating the coated object to a temperature above a melting point of the eutectic composition so as to cause the eutectic composition to melt, thereby forming a liquid layer between the solid layer of material and the solid object.

21. A method according to claim 20, wherein heating of the coated object is performed at least until diffusion or dissolving of the object and/or the layer of material into the liquid layer causes a melting point of the composition of the layer of material and the object to increase above the temperature to which the coated object is heated, thereby causing solidification of the liquid layer.

22. A method according to claim 20, wherein heating of the coated object is performed at least until the entire solid layer of material has been dissolved into the liquid layer.

23. A method according to claim 21, wherein heating of the coated object is performed at least until the entire solid layer of material has been dissolved into the liquid layer.

24. A method according to any of claim 20, wherein heating of the coated object is performed at least until the layer of material is substantially uniformly diffused throughout the coated object.

25. A method according to any of claim 20, wherein the temperature to which the coated object is heated is below a melting point of the metal or alloy from which the object is made.

26. A method according to any of claim 20, wherein the temperature to which the coated object is heated is below a melting point of the material used to coat the object.

27. A method according to any of claim 20, wherein:
the object has a plurality of open cavities;
the steps of coating and heating seals the openings of the open cavities, thereby forming a plurality of closed cavities; and
the method further comprises, after heating the object, reducing the sizes of the closed cavities by performing a consolidation process.

28. A method according to claim 27, wherein the step of reducing the sizes of the closed cavities is performed until the closed cavities are no longer present in the object.

29. A method according to claim 27, wherein the step of performing a consolidation process comprises performing a hot isostatic pressing process.

30. A method according to claim 28, wherein the step of performing a consolidation process comprises performing a hot isostatic pressing process.

31. A method according to any of claim 27, wherein the object is an object that has been produced using a process selected from a group of processes consisting of: net shape manufacturing processes, near net shape manufacturing processes, powder metallurgy processes, spray forming processes, metal injection moulding, direct metal deposition, selective laser melting, additive layer manufacturing, casting, rolling, and forging.

32. A method according to claim 28, wherein the object is an object that has been produced using a process selected from a group of processes consisting of: net shape manufacturing processes, near net shape manufacturing processes, powder metallurgy processes, spray forming processes, metal injection moulding, direct metal deposition, selective laser melting, additive layer manufacturing, casting, rolling, and forging.

33. A method according to claim 29, wherein the object is an object that has been produced using a process selected from a group of processes consisting of: net shape manufacturing processes, near net shape manufacturing processes, powder metallurgy processes, spray forming processes, metal injection moulding, direct metal deposition, selective laser melting, additive layer manufacturing, casting, rolling, and forging.

34. A method according to claim 31, wherein the object is an object that has been produced using additive layer manufacturing.

35. A method according to claim 33, wherein the object is an object that has been produced using additive layer manufacturing.

36. A method according to any of claim 1, wherein the material comprises copper.

37. A method according to any of claim 27, wherein the material comprises copper.

38. A method according to any of claim 1, wherein the metal or alloy from which the object is made is selected from a group of metals or alloys consisting of: titanium alloys, steel, and aluminium alloys.

39. An object that has been processed using a method according to claim 1.
